(19) United States
(12) Patent Application Publication
(10) Pub. No.: US 2013/0266978 A1
(43) Pub. Date: Oct. 10, 2013

(54) METHOD AND DEVICE FOR ESTIMATING MOLECULAR PARAMETERS IN A SAMPLE PROCESSED BY MEANS OF CHROMATOGRAPHY

(71) Applicant: COMMISSARIAT A L'ENERGIE ATOMIQUE ET AUX ENE ALT, (US)

(72) Inventors: Laurent GERFAULT, Voiron (FR); Pierre Grangeat, Saint Ismier (FR)

(73) Assignee: COMMISSARIAT A L'ENERGIE ATOMIQUE ET AUX ENE ALT, Paris (FR)

(21) Appl. No.: 13/857,455

(22) Filed: Apr. 5, 2013

(30) Foreign Application Priority Data
Apr. 5, 2012 (FR) 12 53181

(51) Int. Cl. G01N 27/62

(52) U.S. Cl. CPC G01N 27/62
USPC 435/23; 435/288.6

(57) ABSTRACT

A method for estimating molecular parameters in a sample comprising the following steps: passing the sample through a processing chain including a chromatography step; thereby obtaining a representative signal of molecular parameters as a function of at least one variable of the processing chain; and estimating the molecular parameters using a signal processing device by inverting a direct analytical model of said signal defined as a function of the molecular parameters and technical parameters of the processing chain. Moreover, the processing chain includes a step for multiple measurements of the same product from the chromatography step, the direct analytical model of said signal comprises modelling of this multiple measurement step, and this modelling requires at least one common characteristic of the signals obtained from these multiple measurements.

The present invention relates to a method for estimating molecular parameters in a sample. It also relates to a device provided with means for implementing such a method.

### BACKGROUND OF THE INVENTION

One particularly promising application of such a method is for example the analysis of biological samples such as blood or plasma specimens in order to obtain the biological parameters thereof, such as an estimation of molecular protein concentrations. Knowing these concentrations makes it possible to detect anomalies or diseases. In particular, it is known that some diseases such as cancer, even at a non-advanced stage, may have a potentially detectable impact on the molecular concentrations of some proteins. More generally, the analysis of samples in order to obtain relevant parameters for aiding the diagnosis of a condition (health, pollution, etc.) potentially associated with these samples is a promising area of application of a method according to the invention.

The concrete applications that may be envisaged include the following: biological analysis of samples by means of protein detection; bacteria characterisation by means of mass spectrometry; characterisation of the degree of pollution of a chemical sample (for example, assaying a gas in an environment or assaying a heavy metal in a liquid sample). The relevant molecular parameters obtained may include concentrations of constituents such as molecules (peptides, proteins, enzymes, antibodies, etc.) or molecular assemblies. The term molecular assembly denotes, for example, a nanoparticle or a biological species (bacteria, micro-organism, cell, etc.).

In the case of a biological analysis by means of protein detection, the difficulty is that of obtaining the most accurate estimation possible in an environment subject to interference where the proteins of interest are sometimes present in very small amounts in the sample.

In general, the sample goes through a processing chain comprising a chromatographic column and a mass spectrometer. This processing chain is designed to provide a representative signal of molecular concentrations of the constituents in the sample as a function of a retention time in the chromatography column and at least one mass/load ratio in the mass spectrometer.

Optionally, the processing chain may comprise, upstream from the chromatography column, a centrifuge and/or an affinity capture column, in order to purify the sample. It may further comprise, also upstream from the chromatography column and when the constituents are proteins, a digestion column splitting the proteins into smaller peptides, thus more suitable for the measurement range of the mass spectrometer. Finally, if the processing chain comprises both a chromatography column wherein a liquid phase sample is to pass through, and a mass spectrometer, requiring that the sample be in gas phase, it should further comprise an electrospray (or equivalent) suitable for making the phase change required, in this instance, by spraying the mixture provided at the chromatography column outlet.

In this way, if the processing chain comprises the chromatography column and the mass spectrometer, it is possible to provide a two-dimensional signal wherein the positive amplitude varies as a function of the retention time in the chromatography column in one dimension and at least one mass/load ratio identified by the mass spectrometer in the other dimension. This two-dimensional signal has a multitude of peaks revealing constituent concentrations more or less embedded in the background noise and more or less mutually overlapping.

### DESCRIPTION OF THE PRIOR ART

One known method for estimating constituent concentrations consists of measuring the height of the peaks or the integral thereof (area, volume) above a certain level and deducing the concentration of a corresponding constituent therefrom. A further method known as “spectral analysis” consists of comparing the overall two-dimensional signal to a library of listed models. However, these methods are generally subject to a lack of precision or reliability, particularly if the peaks are not pronounced or rendered less visible due to the background noise or very close overlapping peaks.

A further known method consists of expressing the processing chain analytically and thus obtaining a direct model of the output signal provided, to subsequently estimate the molecular parameters by inverting this model using the signal values actually observed. Such a method is particularly described in the European patent application published under the number EP 2 028 486. It comprises the following steps:
passing the sample through a processing chain including a chromatography step and a mass spectrometry step,
thereby obtaining a representative signal of constituent concentrations of the sample as a function of at least one variable of the processing chain, and
estimating the concentrations using a signal processing device by inverting a direct analytical model of said signal defined as a function of the molecular parameters of the sample, including a representative vector of the concentrations of said constituents and technical parameters of the processing chain.

The analytical modelling proposed in document EP 2 028 486 renders the chromato-spectrometry signal observed dependent on molecular parameters of the sample and technical parameters of the processing chain. The values of some of these parameters are variable or unknown between chromato-spectrometry processes. These parameters are thus modelled by means of mutually independent probability laws and the model inversion is performed by Bayesian inference.

The model proposed in document EP 2 028 486 is sufficiently general to cover a wide diversity of processing chains. However, this has an impact on the precision and reliability of the final estimation.

In particular, if the processing chain includes a tandem mass spectrometry phase, for example using a “Selected Reaction Monitoring” (SRM) spectrometer, some specific aspects of the processing are not taken into account. In particular, the model is not specifically suitable for the fact that two successive spectrometries are carried out, one on a first type of ions, referred to as parent ions, obtained from chromatography products, the other on a second type of ions, referred to as daughter ions, obtained from parent ion fragmentations. As a more general rule, if the chromatography step is followed by a step for fragmenting the products obtained from chromatography and multiple measurements of the fragments obtained from this fragmentation, this specific aspect of the treatment is not taken into account, whereas these multiple measurements, by means of SRM spectrometry or other means, should enable superior characterisation of the molecular parameters of the sample analysed. This fragmentation makes it possible to obtain superior specificity in the characterisation of the molecules to be measured, which is of interest in the analysis of complex mixtures.

The term “multiple measurements” indicates that at least two fragments from the same product are measured. More generally, the expression “multiple measurements” denotes that two different measurements are made using the same product, this product coming from a chromatography column. Such measurements make it possible to distinguish different elements constituting the product, wherein these elements have not been distinguished by the chromatography step. For example, these different elements may be ions resulting from a fragmentation of the product in a mass spectrometer, especially a SRM mass spectrometer.

These multiple measurements may also be obtained by different sensors, for example NEMS sensors, situated downstream of the column, these sensors being arranged to discriminate the contribution of different elements constituting the same product.

It may thus be sought to provide a method for estimating molecular parameters making it possible to do away with at least some of the abovementioned problems and constraints and enhance existing methods.

### SUMMARY OF THE INVENTION

A method for estimating molecular parameters in a sample is thus proposed, comprising the following steps:
passing the sample through a processing chain including a chromatography step,
thereby obtaining a representative signal of molecular parameters as a function of at least one variable of the processing chain, and
estimating the molecular parameters using a signal processing device by inverting a direct analytical model of said signal defined as a function of the molecular parameters and technical parameters of the processing chain,
   and whereby:
the processing chain includes a step for multiple measurements of the same product from the chromatography step,
the direct analytical model of said signal comprises modelling of this multiple measurement step, and
this modelling requires at least one common characteristic of the signals obtained from these multiple measurements.

According to one embodiment, the method is such that:
the processing chain includes a step for fragmenting products from the chromatography step, each fragmentation generating a plurality of fragments,
the processing chain includes a step for measuring a selection of fragments corresponding to the same product, these measures representing multiple measurements in relation to said product,
the direct analytical model of said signal comprises the modelling of this multiple measurement step.

According to one embodiment, this modelling requires at least one common characteristic of the signals obtained from these multiple measurements.

In this way, by integrating a multiple measurement step relating to products obtained from chromatography, for example an SRM spectrometry step, into the processing chain, the associated modelling may be refined, and thus approximate reality, by also integrating, in the model, constraints of common characteristics(s) of the signals obtained from these multiple measurements. Finally, this results in a superior estimation of the molecular parameters in question.

It should be noted that the term “chromatography” generally denotes a molecular analysis process for monitoring a quantity of molecule in the sample over time.

Optionally, said at least one common characteristic comprises a common chromatographic temporal form of the signals obtained.

Also optionally, the multiple measurement step comprises tandem mass spectrometry of products from the chromatography step, for example SRM spectrometry.

Also optionally, the molecular parameters relate to proteins and the sample comprises one of the elements of the set consisting of blood, plasma and urine or any other biological fluid.

Also optionally, the direct analytical model takes the following format:

M_{i,j,k,l}(n)=α_{i,j,k,l}·β_{i,j,k}·gₗ(Y_{i,j,k}(t))·C_{i,j}+ε_{i,j,k,l}(n),

and

M*_{i,j,k,l}(n)=α*_{i,j,k,l}·β_{i,j,k}·gₗ(Y_{i,j,k}(t))·C*_{i,j}+ε*_{i,j,k,l}(n),

i.e.:

Mᵢ:={M_{i,j,k,l}(n);M*_{i,j,k,l}(n)|j=1 . . . J, k=1 . . . K, l=1 . . . L},

where:
n is a discrete time index,
i is an experiment index identifying a sample passage via the processing chain,
j is an index identifying a protein of interest in the sample,
k is an index identifying a peptide from digestion of protein of interest,
l is an index identifying an ionised peptide fragment from tandem mass spectrometry,
Mᵢ is said representative signal of the molecular parameters,
β_{i,j,k} is a yield parameter,
α_{i,j,k,l} and α*_{i,j,k,l} are tandem mass spectrometry yield parameters from the fragmentation steps for non-labelled and labelled proteins, respectively,
ε_{i,j,k,l} and ε*_{i,j,k,l} are processing chain noise parameters for non-labelled and labelled proteins, respectively,
C_{i,j} and C*_{i,j} are concentrations of proteins of interest to be estimated by inverting the direct analytical model,
Y_{i,j,k}(t) is the signal of the ionised peptide, and
gₗ is a function associated with the fragment l binding the fragment signal with the signal of the parent ion thereof Y_{i,j,k}(t).

Also optionally, the direct analytical model is inverted by minimising a squared error according to the least squares criterion or by means of a Bayesian inversion method.

Also optionally, the squared error to be minimised is a regularised squared error in the following format in terms of the ionised peptide fragments:

$${argmin}_{{β}_{i , j , k} , {α}_{i , j , k , l} , {α}_{i , j , k , l}^{*} , {C}_{i , j ,} , {θ}_{i , j , k}} ( \begin{matrix}\frac{1}{{R}_{ijkl}} {‖ \begin{matrix}{M}_{i , j , k , l} ( n ) - \\ {α}_{i , j , k , l} \cdot {β}_{i , j , k} \cdot {C}_{i , j} \cdot {g}_{l} ( {Y}_{i , j , k} ( t , {θ}_{i , j , k} ) )\end{matrix} ‖}^{2} + \\ \frac{1}{{R}_{ijkl}^{*}} {‖ \begin{matrix}{M}_{i , j , k , l}^{*} ( n ) - \\ {α}_{i , j , k , l}^{*} \cdot {β}_{i , j , k} \cdot {C}_{i , j}^{*} \cdot {g}_{l} ( {Y}_{i , j , k} ( t , {θ}_{i , j , k} ) )\end{matrix} ‖}^{2} + \\ μ {‖ {α}_{i , j , k , l} - {α}_{i , j , k , l}^{*} ‖}^{2}\end{matrix} ) ,$$

where:
θ_{i,j,k} is a set of parameters defining the format of representative measurable signal of the peptide k,
R_{i,j,k,l} is a noise variance parameter for the peptide fragment of the protein of interest in question, and
R*_{i,j,k,l} is a noise variance parameter for the same labelled fragment, and
μ is an adjustment or compromise parameter.

A device for estimating molecular parameters in a sample is also proposed, comprising:
a sample processing chain including a chromatography column and means for multiple measurements of products from the chromatography column, the processing chain being designed to provide a representative signal of the molecular parameters as a function of at least one variable of the processing chain, and
a signal processing device designed to apply, in conjunction with the processing chain, a method for estimating molecular parameters as defined above.

Optionally, the processing chain comprises a chromatography column and a tandem mass spectrometer and is designed to provide a representative signal of the constituent concentrations of the sample as a function of the retention time in the chromatography column and a plurality of mass/load ratios in the tandem mass spectrometer.

### BRIEF DESCRIPTION OF THE DRAWINGS

The invention will be understood more clearly using the description hereinafter, given merely as an example and with reference to the appended figures wherein:

FIG. 1 schematically represents the general structure of a device for estimating molecular parameters according to one embodiment of the invention,

FIG. 2 illustrates analytical modelling of a processing chain of the device in FIG. 1, according to one embodiment of the invention, and

FIG. 3 illustrates successive steps for a method for estimating molecular parameters according to one embodiment of the invention.

### DESCRIPTION OF THE PREFERRED EMBODIMENTS

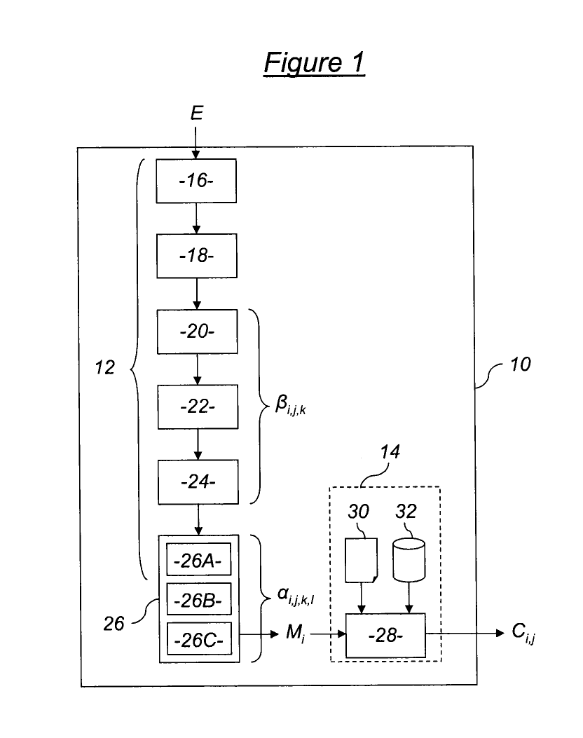

The device 10 for estimating molecular parameters in a sample E, represented schematically in FIG. 1, comprises a chain 12 for processing the sample E designed to provide a representative signal Mᵢ of these molecular parameters as a function of at least one variable of the processing chain 12. It further comprises a device 14 for processing a signal designed to apply, in conjunction with the processing chain 12, a method for estimating molecular parameters. The index i of the signal Mᵢ denotes an experiment, i.e. an i-th passage of the sample E in the processing chain 12.

In the example detailed hereinafter, but which should not be considered to be limiting, the estimated parameters are biological parameters, including biological constituent concentrations of the sample E considered in this case as a biological sample, and the processing chain 12 is a biological processing chain. More specifically, the constituents are proteins of interest, for example selected according to the relevance thereof for characterising an anomaly, disorder or disease, and the sample E is a blood, plasma or urine sample. As a general rule, it consists of a biological fluid, in particular a bodily fluid. The term “molecular protein concentrations” is thus used to denote the concentrations of these specific constituents.

In the biological processing chain 12, the sample E first passes through a centrifuge 16, followed by an affinity capture column 18, in order to be purified.

It then passes through a digestion column 20 splitting the proteins into smaller peptides using an enzyme, for example trypsin.

The sample E then successively passes through a liquid chromatography column 22, an electrospray 24 and a tandem mass spectrometer 26, to provide the signal Mᵢ which is thus representative of the molecular protein concentrations in the sample E as a function of a retention time in the chromatography column 22 and mass/load ratios in the mass spectrometer 26. This signal Mᵢ is the set of chromatograms produced by the biological processing chain 12 for an experiment. It consists of a temporal function representing the amplitude of the signal detected by the mass spectrometer for a transition, a transition being the selection by the mass spectrometer of a parent ion and any of the daughter ions thereof obtained from fragmentation.

The tandem mass spectrometer 26 is more specifically a triple quadrupole SRM mass spectrometer. The first quadrupole 26A is a first analyser selecting a parent ion (i.e. finally an ionised peptide) by mass spectrometry. The mass spectrometer can distinguish, by means of the mass to load ratio, a plurality of ions charged differently from the peptide k. Typically, a single ion is selected. In this way, hereinafter, the same index k for the ion selected from all the ions produced by the ionisation of the peptide will be used. The term ionised peptide will denote this ion. The second quadrupole 26B is a collision cell designed to fragment the parent ion and a plurality of daughter ions. Finally, the third quadrupole 26C is a second analyser selecting a daughter ion from the parent ion by fragmentation.

The passage of the sample E in the digestion column 20, in the liquid chromatography column 22, in the electrospray 24 and in the first stages of the mass spectrometer 26 before fragmentation is performed according to a yield annotated β_{i,j,k}, where i denotes the experiment, j denotes a protein of interest and k denotes a peptide from the digestion column 20. This yield β_{i,j,k} characterises the quantity of peptide k between the appearance thereof (typically after digestion) and the disappearance thereof (typically during fragmentation and the appearance of the by-products thereof). Therefore, in principle, this yield is different between peptides, proteins of interest and experiments.

The passage of the sample E in the SRM mass spectrometer, from the fragmentation stage to signal detection, is performed according to a yield annotated α_{i,j,k,l}, where i denotes the experiment, j denotes a protein of interest, k denotes a peptide from the digestion column 20 and l denotes a fragment of this peptide. More generally, k denotes a product coming from the chromatography column, while l denotes an element that constitutes this product, this element being detected by a measurement made downstream of the chromatography column. Therefore, in principle, this yield is different between fragments, peptides, proteins of interest and experiments. Moreover, it should be noted that a pair of indexes (k,l) identifies a transition, defined as being the selection in the SRM mass spectrometer 26 of a parent ion (index k) from the peptide k and any of the daughter ions thereof (index l) after fragmentation.

The signal Mᵢ is provided at the input of the processing device 14. More specifically, the processing device 14 comprises a processor 28 connected to storage means particularly comprising at least one programmed sequence of instructions 30 and a modelling database 32.

The database 32 comprises the direct modelling parameters of the signal Mᵢ as a function of:
molecular parameters of the sample E, including molecular concentrations C_{i,j} of the proteins of interest, where i denotes the experiment and j denotes a protein of interest,
the abovementioned technical parameters β_{i,j,k} and α_{i,j,k,l} of the biological processing chain 12,
a measured signal model M_{i,j,k,l} for a fragment of a peptide in question, and
further technical parameters ε_{i,j,k,l} of the biological processing chain 12, representative of measurement noise, said noise being, in principle, different between fragments, peptides, proteins of interest and experiments.

It should be noted that some technical parameters of the processing chain are not known in absolute terms and without this absolute knowledge, it is not possible to estimate the concentration C_{i,j} of the proteins of interest in absolute terms. In practice, this problem is solved by inserting labelling proteins equivalent to the proteins of interest (but having a different mass) in the sample E before the passage thereof in the processing chain 12. The concentration C_{i,j}* of these labelling proteins is known, such that the technical parameters and the concentration C_{i,j} may thus be estimated using C_{i,j}* and a comparison of the peaks corresponding to the proteins of interest and the labelling proteins in the signal observed Mᵢ.

According to one alternative embodiment, other labelled molecules such as labelled peptides may be injected in conjunction with or instead of labelled proteins.

According to the invention, constraints are applied to the direct model of the signal Mᵢ. Since the step following the chromatography comprises a plurality of measurements of representative signals of products of this chromatography, the model requires at least one common characteristic between signals obtained from these multiple measurements. In particular, in the example in FIG. 1, the passage of ionised peptides in the SRM mass spectrometer 26 induces a plurality of measurable representative signals of a plurality of fragments of these peptides which are produced by the collision cell 26B. The model thus assumes that the temporal form of the representative signals of the L fragments of the same parent peptide is based on the chromatographic temporal form of the representative signal of the parent peptide for the same experiment. If Y_{i,j,k}(t) is taken to be this temporal form, the signal Y_{i,j,k,l}(n) at the discrete time n of fragment l may be defined such that:

Y_{i,j,k,l}(n)=gₗ(Y_{i,j,k}(t)),

where gₗ is a function associated with the fragment l linking the continuous time temporal signal of the signal of the precursor ion Y_{i,j,k}(t). More specifically, the function gₗ performs time sampling and integration of the continuous signal Y_{i,j,k}(t). Thus, the signal Y_{i,j,k,l}(n) corresponds to a signal which is representative of an element l constituting the product k. In this example, the element l comes from the fragmentation of product k. In the example of an embodiment shown, the function gₗ is considered to be independent of the fragment l, and the response of the detector to be linear, which corresponds to a particular case.

This constraint is conveyed by the following equation relating to the model Y_{i,j,k,l}:

∀l, 1≦l≦L, Y_{i,j,k,l}=Y_{i,j,k}.

It is also assumed that the model Y_{i,j,k} is optionally independent of labelling of the proteins of interest, conveyed by the following annotation:

Y_{i,j,k}=Y*_{i,j,k}.

Also in the example in FIG. 1, it is assumed that the yield β_{i,j,k} associated with the steps applied to the peptide k is optionally independent of labelling of the proteins of interest, conveyed by the following annotation:

β_{i,j,k}=β*_{i,j,k}.

These two equations are justified by common chemical properties of the products passing through the digestion, liquid chromatography, electrospray steps and the first stages of the mass spectrometer.

On the other hand, the yield α_{i,j,k,l} of the SRM mass spectrometry steps from the fragmentation is, in principle, different according to whether the proteins are labelled or not. This choice in the model is not obvious since it is conventionally considered that labelled and non-labelled molecules have strictly the same behaviour. However, this choice enables a more accurate adaptation to the data even if they are different to the direct model. This case arises for example when adding the signal from a contaminant to the signals of labelled molecules and not to those of non-labelled molecules.

Similarly, the noise parameters ε_{i,j,k,l} are dependent on whether the proteins are labelled but are all assumed to observe normal zero mean laws. Otherwise, the data may be transformed to obtain a noise statistic similar to that mentioned above, such as the Anscombe transform.

As a result, if M_{i,j,k,l}(n) denotes the representative signal model of the fragment l of the peptide k of the protein j of the experiment i, and M*_{i,j,k,l}(n) the model of the same labelled fragment, the direct analytical model chosen stipulates:

M_{i,j,k,l}(n)=α_{i,j,k,l}·β_{i,j,k}·Y_{i,j,k}(n)·C_{i,j}+ε_{i,j,k,l}(n)

and

M*_{i,j,k,l}(n)=α*_{i,j,k,l}·β_{i,j,k}·Y_{i,j,k}(n)·C*_{i,j}+ε*_{i,j,k,l}(n),

i.e.:

Mᵢ:={M_{i,j,k,l}(n);M*_{i,j,k,l}(n)|j=1 . . . J, k=1 . . . K, l=1 . . . L},

On providing the signals actually observed and M_{i,j,k,l} and M*_{i,j,k,l}, the programmed instruction sequence 30 is designed to solve the inversion of this analytical model, for example by minimising the squared error according to the least squares criterion, which may be expressed as following, for signals acquired from a fragment and the labelled counterpart thereof:

$${argmin}_{{β}_{i , j , k} , {α}_{i , j , k , l} , {α}_{i , j , k , l}^{*} , {C}_{i , j ,} , {θ}_{i , j , k}} ( \begin{matrix}{‖ \begin{matrix}{M}_{i , j , k , l} ( n ) - \\ {α}_{i , j , k , l} \cdot {β}_{i , j , k} \cdot {C}_{i , j} \cdot {Y}_{i , j , k} ( n , {θ}_{i , j , k} )\end{matrix} ‖}^{2} + \\ {‖ \begin{matrix}{M}_{i , j , k , l}^{*} ( n ) - \\ {α}_{i , j , k , l}^{*} \cdot {β}_{i , j , k} \cdot {C}_{i , j}^{*} \cdot {Y}_{i , j , k} ( n , {θ}_{i , j , k} )\end{matrix} ‖}^{2} +\end{matrix} ) ,$$

where θ_{i,j,k} is a set of parameters defining the format of the representative measurable signal of the peptide k. These parameters may particularly include descriptive parameters of the position and width of the peak of the signal.

However, in this simplified form, the squared error offers limited performances since it is unstable and displays very rapid variations. It may thus be optimised by weighting the least squares criterion with the noise inverse-variance. This weighting penalises signals having a low signal-to-noise ratio and thus adjusts the contribution thereof to the determination of parameters. Each residue making up the sum above is therefore advantageously controlled by a penalisation term. This weighted expression of the least squares criterion ensures that the measurements subject to the most noise do not have a greater influence than the other measurements on the solution obtained. This enables automatic management of different quality signals, without selecting measurements to be made by an operator, unlike known techniques in general.

The squared error may thus be regularised as follows:

$${argmin}_{{β}_{i , j , k} , {α}_{i , j , k , l} , {α}_{i , j , k , l}^{*} , {C}_{i , j ,} , {θ}_{i , j , k}} ( \begin{matrix}\frac{1}{{R}_{ijkl}} {‖ \begin{matrix}{M}_{i , j , k , l} ( n ) - \\ {α}_{i , j , k , l} \cdot {β}_{i , j , k} \cdot {C}_{i , j} \cdot {Y}_{i , j , k} ( n , {θ}_{i , j , k} )\end{matrix} ‖}^{2} + \\ \frac{1}{{R}_{ijkl}^{*}} {‖ \begin{matrix}{M}_{i , j , k , l}^{*} ( n ) - \\ {α}_{i , j , k , l}^{*} \cdot {β}_{i , j , k} \cdot {C}_{i , j}^{*} \cdot {Y}_{i , j , k} ( n , {θ}_{i , j , k} )\end{matrix} ‖}^{2} +\end{matrix} )$$

In this regularised expression, R_{i,j,k,l} is a noise variance parameter for the peptide fragment of the protein of interest in question and R*_{i,j,k,l} is a noise variance parameter for the same labelled fragment. R_{i,j,k,l} and R*_{i,j,k,l} and may be estimated as the variance of:
a signal portion wherein the signal of the fragment is zero (the portion of the signal of interest is considered to only contain noise),
a signal approximating the noise as a difference between the measurement and the filtered measurement; in this case, the filtered measurement is an approximation of the signal model.

The squared error may also be regularised as follows:

$${argmin}_{{β}_{i , j , k} , {α}_{i , j , k , l} , {α}_{i , j , k , l}^{*} , {C}_{i , j ,} , {θ}_{i , j , k}} ( \begin{matrix}\frac{1}{{R}_{ijkl}} {‖ \begin{matrix}{M}_{i , j , k , l} ( n ) - \\ {α}_{i , j , k , l} \cdot {β}_{i , j , k} \cdot {C}_{i , j} \cdot {Y}_{i , j , k} ( n , {θ}_{i , j , k} )\end{matrix} ‖}^{2} + \\ \frac{1}{{R}_{ijkl}^{*}} {‖ \begin{matrix}{M}_{i , j , k , l}^{*} ( n ) - \\ {α}_{i , j , k , l}^{*} \cdot {β}_{i , j , k} \cdot {C}_{i , j}^{*} \cdot {Y}_{i , j , k} ( n , {θ}_{i , j , k} )\end{matrix} ‖}^{2} + \\ μ {‖ {α}_{i , j , k , l} - {α}_{i , j , k , l}^{*} ‖}^{2}\end{matrix} ) .$$

Also in this regularised expression, the parameter μ acts as an adjustment or compromise parameter. For a higher value of this parameter μ, the difference in the gains of the transitions of the SMR spectrometry step is penalised significantly. This tends to adopt transition gain equality as a signal model. For a zero value of the parameter μ, there is no constraint on transition gain estimations. This parameter can be estimated by varying same on test acquisitions and verifying the stability of the solutions obtained and/or the correspondence of these estimations in relation to the expected value if known.

In sum, the squared error equation to be minimised assumes the use of three previously estimated terms, R_{i,j,k,l}, R*_{i,j,k,l} and μ.

It is noted that this minimisation is performed in terms of peptide fragments. In this way, after performing this minimisation in a manner known per se, the estimated parameters may be reassessed in the light of all the signals in terms of peptides.

In concrete terms, for each peptide, the minimisation criterion is the minimisation of the sum of the minimisation criteria of all the fragments from the peptide in question, i.e.:

$${argmin}_{{β}_{i , j , k} , {α}_{i , j , k , l} , {α}_{i , j , k , l}^{*} , {C}_{i , j ,} , {θ}_{i , j , k}} ( {\sum }_{l} [ \begin{matrix}\frac{1}{{R}_{ijkl}} {‖ \begin{matrix}{M}_{i , j , k , l} ( n ) - {α}_{i , j , k , l} \cdot \\ {β}_{i , j , k} \cdot {C}_{i , j} \cdot {Y}_{i , j , k} ( n , {θ}_{i , j , k} )\end{matrix} ‖}^{2} + \\ \frac{1}{{R}_{ijkl}^{*}} {‖ \begin{matrix}{M}_{i , j , k , l}^{*} ( n ) - {α}_{i , j , k , l}^{*} \cdot \\ {β}_{i , j , k} \cdot {C}_{i , j}^{*} \cdot {Y}_{i , j , k} ( n , {θ}_{i , j , k} )\end{matrix} ‖}^{2} + \\ μ {‖ {α}_{i , j , k , l} - {α}_{i , j , k , l}^{*} ‖}^{2}\end{matrix} ] ) .$$

This minimisation induces the same number of estimations of concentrations C_{i,j} as peptides.

After this minimisation has been performed in a manner known per se in terms of peptides, the estimated parameters may be reassessed in the light of all the signals in terms of proteins.

In concrete terms, for each protein, the minimisation criterion is the minimisation of the sum of the minimisation criteria of all the peptides from the protein in question, i.e.:

$${argmin}_{β , C} ( {\sum }_{k} {\sum }_{l} [ \begin{matrix}\frac{1}{{R}_{ijkl}} {‖ \begin{matrix}{M}_{i , j , k , l} ( n ) - {α}_{i , j , k , l} \cdot \\ {β}_{i , j , k} \cdot {C}_{i , j} \cdot {Y}_{i , j , k} ( n , {θ}_{i , j , k} )\end{matrix} ‖}^{2} + \\ \frac{1}{{R}_{ijkl}^{*}} {‖ \begin{matrix}{M}_{i , j , k , l}^{*} ( n ) - {α}_{i , j , k , l}^{*} \cdot \\ {β}_{i , j , k} \cdot {C}_{i , j}^{*} \cdot {Y}_{i , j , k} ( n , {θ}_{i , j , k} )\end{matrix} ‖}^{2} + \\ μ {‖ {α}_{i , j , k , l} - {α}_{i , j , k , l}^{*} ‖}^{2}\end{matrix} ] ) .$$

However, as seen in the above formula, it may be chosen only to reassess some of the parameters, in this instance the parameters β and C.

Alternatively, the inversion as detailed above could be resolved in a Bayesian framework by means of an a posteriori estimation based on probability models, for example prior models of at least some of the abovementioned parameters. In this case, reference may be made to the document EP 2 028 486.

The instruction sequence 30 and the database 32 are functionally represented as separate in FIG. 1, but in practice they may be broken down differently into data files, source codes or data libraries without changing the functions fulfilled in any way.

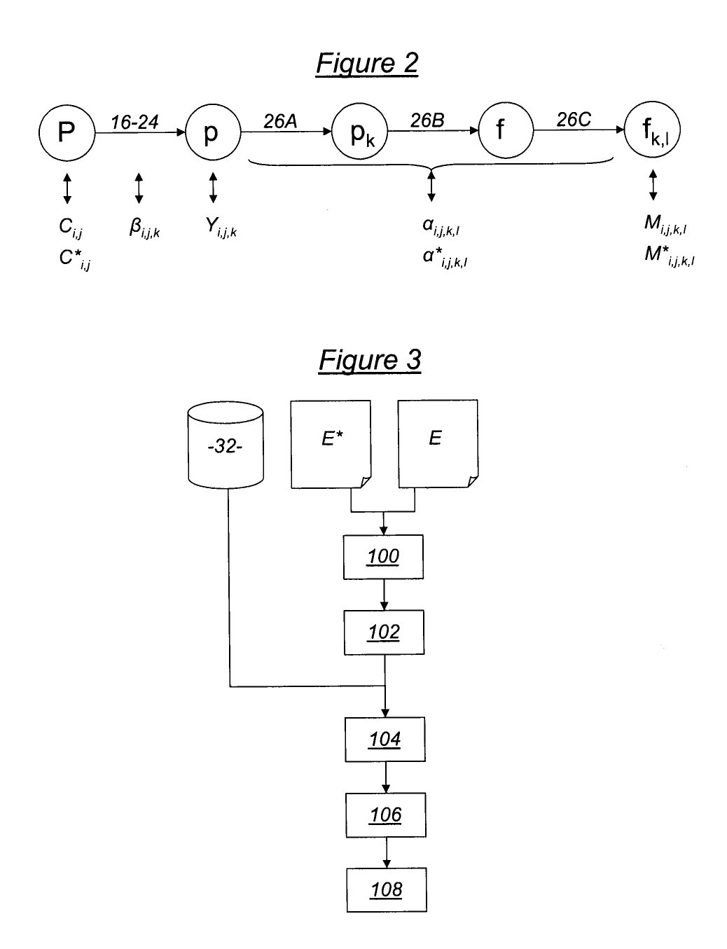

As illustrated in FIG. 2, the parameters of the processing chain 12 are interconnected so as to form an overall model having a hierarchy due to the similarity of the models of the representative signals of the daughter ions (f_{k,l}) of the same parent ion (pₖ) treated by SRM spectrometry. The proteins P are associated with the concentrations C_{i,j} and C*_{i,j} to be determined by inversion. Following the chromatography and spraying step, and the steps relating to the mass spectrometer stages upstream from the fragmentation, the yield whereof is modelled by the parameters β_{i,j,k}, peptides p are identifiable by the modelled signals Y_{i,j,k}. Finally, in the SRM mass spectrometer 26 wherein the yield from the fragmentation is modelled by the parameters β_{i,j,k,l} and α*_{i,j,k,l}, the parent ions pₖ may be identified before being fragmented to daughter ions f suitable in turn for being identified individually (f_{k,l}) using the measurements M_{i,j,k,l} and M*_{i,j,k,l}. The yields and α_{i,j,k,l} and α*_{i,j,k,l} correspond to the yields of the fragmentation stage and the following stages.

The method for estimating molecular parameters illustrated in FIG. 3 comprises a first measurement step 100 wherein, according to the set-up in FIG. 1, the sample E whereto the labelling proteins E* have been added passes through the entire processing chain 12 of the device 10. This step is identified as an experiment having the index i.

The set of measured signals Mᵢ is thus output from the SRM spectrometer 26 during a step 102.

During a step 104 implemented by the processor 28 on execution of the programmed instruction sequence 30, the concentrations C_{i,j} of proteins of interest are estimated, among the other technical parameters of the processing chain 12, by inverting the direct analytical model detailed above, in terms of the ionised peptides outputs from the second analyser 26C.

During a step 106 implemented by the processor 28 on execution of the programmed instruction sequence 30, the concentrations C_{i,j} of proteins of interest are reassessed, among the other technical parameters of the processing chain 12, by inverting the direct analytical model detailed above, in terms of the ionised peptides input from the first analyser 26A.

Finally, during a step 108 implemented by the processor 28 on execution of the programmed instruction sequence 30, the concentrations C_{i,j} of proteins of interest are reassessed, among some of the other technical parameters of the processing chain 12, by inverting the direct analytical model detailed above, in terms of the proteins input from the digestion column 20.

It is clear that a method such as that described above, implemented by the estimation device 10, enables, by means of judicious direct modelling of the signal observed at the output of the processing chain 12, the provision of a reliable estimation of molecular parameters (for example concentrations) of predetermined constituents of interest such as proteins. In particular, this method excels in correctly evaluating measurement peaks in the presence of significant noise or overlapping with other chromatogram peaks, where conventional peak analysis or spectral analysis are less satisfactory.

Concrete applications of this method particularly include detecting cancer markers (in this case, the constituents of interest are proteins) in a biological blood or urine sample.

More generally, there are numerous fields of application, ranging from enhancing the specificity of SRM mass spectrometers to automated molecule quantification.

Enhancing the specificity of SRM mass spectrometers is enabled by using the common temporal form of the various transitions of the same parent ion in the direct analytical model used.

Similarly, automated molecule quantification is enabled by the use of a signal model integrating a data redundancy in the measurable signals. In a Bayesian approach, this redundancy, which is a legacy of the characteristics of a parent ion to the daughter fragments, may be formulated according to a hierarchical model. For this, reference may be made to the French patent application FR 1153008, filed on 6 Apr. 2011, not published on the date of filing of the present application. In an inversion-based approach using least-squares squared error minimisation, this hierarchical model becomes deterministic.

Moreover, it should be noted that the invention is not limited to the embodiment described above. Indeed, it would be obvious to those skilled in the art that various modifications may be made to the embodiment described above, in the light of the teaching disclosed herein.

In particular, the constituents of interest are not necessarily proteins, but may be more generally molecules or molecular assemblies for a biological or chemical analysis.

In particular also, the step for multiple measurements of products from the chromatography step is not necessarily SRM type tandem spectrometry.

More generally, in the claims hereinafter, the terms used should not be interpreted as limiting the claims to the embodiments disclosed in the present description, but should be interpreted to include any equivalents that the claims are intended to cover due to the wording thereof and which may be envisaged by those skilled in the art by applying their general knowledge to the implementation of the teaching disclosed herein.

1. A method for estimating molecular parameters in a sample, comprising the following steps:
passing the sample through a processing chain including a chromatography step,
thereby obtaining a representative signal of molecular parameters as a function of at least one variable of the processing chain, and
estimating the molecular parameters using a signal processing device by inverting a direct analytical model of said signal defined as a function of the molecular parameters and technical parameters of the processing chain,
wherein:
the processing chain includes a step for multiple measurements of the same product from the chromatography step,
the direct analytical model of said signal comprises modelling of this multiple measurement step, and
this modelling requires at least one common characteristic of the signals obtained from these multiple measurements.

2. The method for estimating molecular parameters as claimed in claim 1, wherein said at least one common characteristic comprises a common chromatographic temporal form of the signals obtained.

3. The method for estimating molecular parameters as claimed in claim 1, wherein the multiple measurement step comprises tandem mass spectrometry of products from the chromatography step, for example SRM spectrometry.

4. The method for estimating molecular parameters as claimed in claim 1, wherein the molecular parameters relate to proteins and the sample comprises one of the elements of the set consisting of blood, plasma and urine or any other biological fluid.

5. The method for estimating molecular parameters as claimed in claim 3, wherein the direct analytical model takes the following format:
M_{i,j,k,l}(n)=α_{i,j,k,l}·β_{i,j,k}·gₗ(Y_{i,j,k}(t))·C_{i,j}+ε_{i,j,k,l}(n)
and
M*_{i,j,k,l}(n)=α*_{i,j,k,l}·β_{i,j,k}·gₗ(Y_{i,j,k}(t))·C*_{i,j}+ε*_{i,j,k,l}(n),
i.e.:
Mᵢ:={M_{i,j,k,l}(n);M*_{i,j,k,l}(n)|j=1 . . . J, k=1 . . . K, l=1 . . . L},
where:
n is a discrete time index,
i is an experiment index identifying a sample passage via the processing chain,
j is an index identifying a protein of interest in the sample,
k is an index identifying a peptide from digestion of protein of interest,
l is an index identifying an ionised peptide fragment from tandem mass spectrometry,
Mᵢ is said representative signal of the molecular parameters,
β_{i,j,k} is a yield parameter,
α_{i,j,k,l} and α*_{i,j,k,l} and are tandem mass spectrometry yield parameters from the fragmentation steps for non-labelled and labelled proteins, respectively,
ε_{i,j,k,l} and ε*_{i,j,k,l} are processing chain noise parameters for non-labelled and labelled proteins, respectively,
C_{i,j} and C*_{i,j} are concentrations of proteins of interest to be estimated by inverting the direct analytical model,
Y_{i,j,k}(t) is the signal of the ionised peptide, and
gₗ is a function associated with the fragment l binding the fragment signal with the signal of the parent ion thereof Y_{i,j,k}(t).

6. The method for estimating molecular parameters as claimed in claim 1, wherein the direct analytical model is inverted by minimising a squared error according to the least squares criterion or by means of a Bayesian inversion method.

7. The method for estimating molecular parameters as claimed in claim 6, wherein the squared error to be minimised is a regularised squared error in the following format in terms of the ionised peptide fragments:
$${argmin}_{{β}_{i , j , k} , {α}_{i , j , k , l} , {α}_{i , j , k , l}^{*} , {C}_{i , j ,} , {θ}_{i , j , k}} ( \begin{matrix}\frac{1}{{R}_{ijkl}} {‖ \begin{matrix}{M}_{i , j , k , l} ( n ) - \\ {α}_{i , j , k , l} \cdot {β}_{i , j , k} \cdot {C}_{i , j} \cdot {g}_{l} ( {Y}_{i , j , k} ( t , {θ}_{i , j , k} ) )\end{matrix} ‖}^{2} + \\ \frac{1}{{R}_{ijkl}^{*}} {‖ \begin{matrix}{M}_{i , j , k , l}^{*} ( n ) - \\ {α}_{i , j , k , l}^{*} \cdot {β}_{i , j , k} \cdot {C}_{i , j}^{*} \cdot {g}_{l} ( {Y}_{i , j , k} ( t , {θ}_{i , j , k} ) )\end{matrix} ‖}^{2} + \\ μ {‖ {α}_{i , j , k , l} - {α}_{i , j , k , l}^{*} ‖}^{2}\end{matrix} ) ,$$
where:
θ_{i,j,k} is a set of parameters defining the format of representative measurable signal of the peptide k,
R_{i,j,k,l} is a noise variance parameter for the peptide fragment of the protein of interest in question, and
R*_{i,j,k,l} is a noise variance parameter for the same labelled fragment, and
μ is an adjustment or compromise parameter.

8. A device for estimating molecular parameters in a sample, comprising:
a sample processing chain including a chromatography column and means for multiple measurements of products from the chromatography column, the processing chain being designed to provide a representative signal of the molecular parameters as a function of at least one variable of the processing chain, and
a signal processing device comprising:
a modelling database comprising parameters of a direct analytical model of the signal provided by the processing chain, said direct analytical model being defined as a function of the molecular parameters and technical parameters of the processing chain,
a programmed sequence of instructions stored in memory to estimate the molecular parameters by inverting the direct analytical model,
a processor for executing said programmed sequence of instructions,
wherein:
said multiple measurement means include means for multiple measurements of the same product from the chromatography column,
the analytical model, the parameters of which are stored in the database, comprises a modelling of these multiple measurements means, wherein this modelling requires at least one common characteristic of the signals obtained from these multiple measurements.

9. The device for estimating molecular parameters as claimed in claim 8, wherein the processing chain comprises a chromatography column and a tandem mass spectrometer and is designed to provide a representative signal of the constituent concentrations of the sample as a function of the retention time in the chromatography column and a plurality of mass/load ratios in the tandem mass spectrometer.
